(19) United States
(12) Patent Application Publication
(10) Pub. No.: US 2017/0192436 A1
(43) Pub. Date: Jul. 6, 2017

(54) AUTONOMOUS DRIVING SERVICE SYSTEM FOR AUTONOMOUS DRIVING VEHICLE, CLOUD SERVER FOR THE SAME, AND METHOD FOR OPERATING THE CLOUD SERVER

(71) Applicant: Electronics and Telecommunications Research Institute, Daejeon (KR)

(72) Inventors: Kyoung Wook MIN, Sejong-si (KR); Kyung Bok SUNG, Daejeon (KR); Jeong Dan CHOI, Daejeon (KR); Seung Jun HAN, Daejeon (KR); Joo Chan SOHN, Daejeon (KR)

(73) Assignee: Electronics and Telecommunications Research Institute, Daejeon (KR)

(21) Appl. No.: 15/198,017

(22) Filed: Jun. 30, 2016

(30) Foreign Application Priority Data
Jan. 5, 2016 (KR) 10-2016-0000876

(51) Int. Cl. G05D 1/02; G01C 21/34

(52) U.S. Cl. CPC G05D 1/0276; G01C 21/34; G05D 1/0246; G05D 1/0257

(57) ABSTRACT

Disclosed are an autonomous driving service system for an autonomous driving vehicle, a cloud server for the same, and a method for operating the cloud server. The autonomous driving service system for the autonomous driving vehicle according to an embodiment of the present invention includes a user terminal that requests autonomous driving map data used for an autonomous driving vehicle to perform autonomous driving from a departure point set in advance to a destination, and a cloud server that establishes and manages precise map data based on raw data collected from a plurality of collection vehicles which are driving in mutually different locations, acquires the autonomous driving map data by searching for the precise map data in response to the request for autonomous driving map data of the user terminal, and transmits the acquired autonomous driving map data to the autonomous driving vehicle.

### CROSS-REFERENCE TO RELATED APPLICATION

This application claims priority to and the benefit of Korean Patent Application No. 10-2016-0000876, filed on Jan. 5, 2016, the disclosure of which is incorporated herein by reference in its entirety.

### BACKGROUND

1. Field of the Invention

The present invention relates to an autonomous driving technology for a vehicle, and more particularly, to an autonomous driving service system for an autonomous driving vehicle based on a cloud server, and a method for operating the same.

2. Discussion of Related Art

In order for a vehicle to drive (autonomous driving) itself in an unattended manner, the accuracy of navigation map data must be at least 30 cm or less. However, an error of legacy navigation map data that is produced on the basis of survey data of the National Geographic Information Institute reaches several meters. In addition, a road network of the legacy navigation map data is constituted of links for each lane, which makes its utilization impossible.

Due to this reason, separate autonomous driving map data may be utilized for the autonomous driving of a vehicle. The autonomous driving map data includes static data of landmarks such as road mark data, traffic signs, road signs, traffic lights, etc., and road network data for each lane which is extracted from the static data. That is, only the presence of the accurate road network data for each lane makes autonomous driving possible.

Each of a plurality of pieces of the road network data for each lane basically includes attribute information and position information (x, y, and z). In addition, the road network data for each lane is more detailed than legacy navigation data (a background map, road network data, POI (Point Of Interest) data, and the like) and has a larger quantity (size) than that of the legacy navigation data.

The autonomous driving map data is the most basic data in the autonomous driving technology, and utilization thereof is as follows.

First, position and posture of a vehicle is recognized using the autonomous driving map data. When using a GPS, a shadow region is present in a building-concentrated area and an expensive GPS is a barrier to its commercialization. Thus, map recognition information and a precise map which is made into a database (DB) may be mapped and calculated using precise map data and a vision sensor mounted in a vehicle, so that posture and position information of the vehicle may be calculated.

Second, road route guidance (routing) for each lane is made possible using the autonomous driving map data. Using the road network data for each lane extracted from road marks, the autonomous driving map data may be used to extract routing data between a departure point and a destination.

Third, a control for a vehicle is made possible through map mapping with an obstacle using the autonomous driving map data. By mapping the obstacle (other vehicles, a walking moveable body, etc.) onto a precise map, a mission such as a vehicle avoiding, bypassing, or passing the obstacle may be performed. For example, precise map data may be utilized when determining whether the vehicle can avoid the obstacle without departing from an avoidable region, that is, a road in order to avoid a collision between the vehicle and the obstacle.

Conventionally, in terms of a smart phone (user terminal)-based navigation service, background map data for basic expression is stored in a smart phone. In addition, road route guidance from the departure point to the destination is performed in a server and is transmitted to the smart phone using communication together with guidance information, and driving guidance is performed based on this.

At the time when domestic large companies have started to establish precise map data, a method and system for services of the precise map data are currently absent.

### SUMMARY OF THE INVENTION

The present invention is directed to an autonomous driving service system for an autonomous driving vehicle and a method for operating a cloud server which collects precise map data for autonomous driving and provides map data for autonomous driving to a vehicle desiring to perform autonomous driving.

According to an aspect of the present invention, there is provided an autonomous driving service system for an autonomous driving vehicle including: a user terminal that requests autonomous driving map data used for the autonomous driving vehicle to perform autonomous driving from a departure point set in advance to a destination; and a cloud server that establishes and manages precise map data based on raw data collected from a plurality of collection vehicles which are driving in mutually different locations, acquires the autonomous driving map data by searching for the precise map data in response to the request for autonomous driving map data of the user terminal, and transmits the acquired autonomous driving map data to the autonomous driving vehicle.

Here, the raw data may be feature data including at least one of image data acquired via a vision sensor provided in each of the plurality of collection vehicles, road mark-shaped geometry information extracted from the image data, and position information of landmarks.

Also, the cloud server may receive the raw data from at least one of an MMS (mobile mapping system) vehicle equipped with an MMS and an ADAS (advanced driving assistance system) vehicle equipped with an ADAS.

Also, when it is switched into an autonomous driving mode, the user terminal may transmit an autonomous driving map data request command including profile information, departure point information, and destination information of the autonomous driving vehicle to the cloud server.

Also, the cloud server may transmit the autonomous driving map data to the autonomous driving vehicle corresponding to unique identification (ID) information included in the profile information.

Also, the cloud server may include a precise map generation unit that generates the precise map data based on the received raw data, a storage unit that stores the precise map data generated by the precise map data generation unit, and an autonomous driving map providing unit that acquires the autonomous driving map data for the autonomous driving vehicle to reach the destination by searching for the precise map data stored in the storage unit when receiving the autonomous driving map data request command, and transmits the acquired autonomous driving map data to the autonomous driving vehicle.

Also, the autonomous driving map providing unit may acquire the autonomous driving map data including a road-level route and guidance information for the autonomous driving vehicle to reach the destination, a lane-level route including lane information about a lane in which the autonomous driving vehicle should drive on a road in accordance with the road-level route, and a mission of a point at which a change in driving of the autonomous driving vehicle is required, by searching for the precise map data of the storage unit.

According to another aspect of the present invention, there is provided a cloud server for providing autonomous driving service of an autonomous driving vehicle, including: a precise map generation unit that generates precise map data based on a plurality of pieces of raw data for a road in mutually different locations; a storage unit that stores the generated precise map data; and an autonomous driving map providing unit that acquires autonomous driving map data for an autonomous driving vehicle to reach a destination set in advance by searching for the precise map data stored in the storage unit when an autonomous driving map data request command is received, and transmits the acquired autonomous driving map data to the autonomous driving vehicle.

Here, the raw data may be feature data including at least one of image data acquired in mutually different locations, road mark-shaped geometry information extracted from the image data, and position information of landmarks.

Also, the autonomous driving map providing unit may acquire the autonomous driving map data including a road-level route and guidance information for the autonomous driving vehicle to reach the destination, a lane-level route including lane information about a lane in which the autonomous driving vehicle should drive on a road in accordance with the road-level route, and a mission of a point at which a change in driving of the autonomous driving vehicle is required, by searching for the precise map data of the storage unit.

Also, the raw data may be received from at least one of an MMS vehicle equipped with an MMS and an ADAS vehicle equipped with an ADAS.

Also, the autonomous driving map data request command may include profile information, departure point information, and destination information of the autonomous driving vehicle.

Also, the autonomous driving map providing unit may transmit the autonomous driving map data to the autonomous driving vehicle corresponding to unique ID information included in the profile information.

According to still another aspect of the present invention, there is provided a method for operating a cloud server of an autonomous driving service system for an autonomous driving vehicle, including: receiving raw data for a road in mutually different locations; generating and storing precise map data based on the raw data; acquiring autonomous driving map data for the autonomous driving vehicle to perform autonomous driving from a departure point set in advance to a destination by searching for the precise map data; and transmitting the acquired autonomous driving map data to the autonomous driving vehicle.

Here, the acquiring may include searching for the precise map data when receiving an autonomous driving map data request command including profile information, departure point information, and destination information of the autonomous driving vehicle.

Also, the raw data may be feature data including at least one of image data of the road, road mark-shaped geometry information extracted from the image data, and position information of landmarks.

Also, the receiving may include receiving the raw data from at least one of an MMS vehicle equipped with an MMS and an ADAS vehicle equipped with an ADAS.

Also, the autonomous driving map data may include a road-level route and guidance information for reaching the destination from the departure point, a lane-level route including lane information about a lane in which the corresponding vehicle should drive in accordance with the road-level route, and a mission of a point at which a change in driving of the autonomous driving vehicle is required, by searching for the precise map data.

Also, the transmitting may include transmitting the autonomous driving map data to the autonomous driving vehicle corresponding to a unique ID included in the profile information.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a conceptual diagram illustrating an autonomous driving service system for an autonomous driving vehicle according to an embodiment of the present invention;

FIG. 2 is a diagram for describing an operation of collecting raw data by a plurality of collection vehicles according to an embodiment of the present invention;

FIG. 3 is a block diagram illustrating a cloud server of an autonomous driving service system for an autonomous driving vehicle according to an embodiment of the present invention;

FIG. 4A, FIG. 4B, FIG. 4C and FIG. 4D are a diagram for describing an operation of matching raw data collected by a plurality of collection vehicles according to an embodiment of the present invention;

FIG. 5 is a diagram for describing the overall operation of an autonomous driving service system for an autonomous driving vehicle according to an embodiment of the present invention;

FIG. 6 is a diagram for describing an operation of searching for and acquiring autonomous driving map data in a cloud server according to an embodiment of the present invention; and

FIG. 7 is a reference diagram for describing an example of an operation of an autonomous driving service system for an autonomous driving vehicle according to an embodiment of the present invention.

FIG. 8 is a block diagram illustrating a computer system for the present invention.

### DETAILED DESCRIPTION OF EXEMPLARY EMBODIMENTS

Advantages and features of the present invention and a method for achieving the same will become explicit by referring to the exemplary embodiments that are described in detail in the following with reference to the accompanying drawings. However, the present invention is not limited to the exemplary embodiments disclosed in the following and thus, may be configured in various forms. Here, the present exemplary embodiments are provided to make the disclosure of the present invention perfect and to completely inform those skilled in the art about the scope of the present invention. The present invention is defined by the scope of claims.

Meanwhile, terminologies used in the present specification are to describe the exemplary embodiments and not to limit the present invention. In the present specification, unless particularly described in the description, a singular form includes a plural form. “Comprises/includes” and/or “comprising/including” used in the specification does not exclude the presence or addition of at least one another constituent element, step, operation, and/or device with respect to the described constituent element, step, operation/or device.

Hereinafter, the exemplary embodiments of the present invention will be described in detail with reference to the accompanying drawings. First, in adding reference numerals to components throughout the drawings, it is to be noted that like reference numerals designate like components even though components are shown in different drawings. Further, when it is determined that the detailed description of the known art related to the present invention may obscure the gist of the present invention, the detailed description thereof will be omitted.

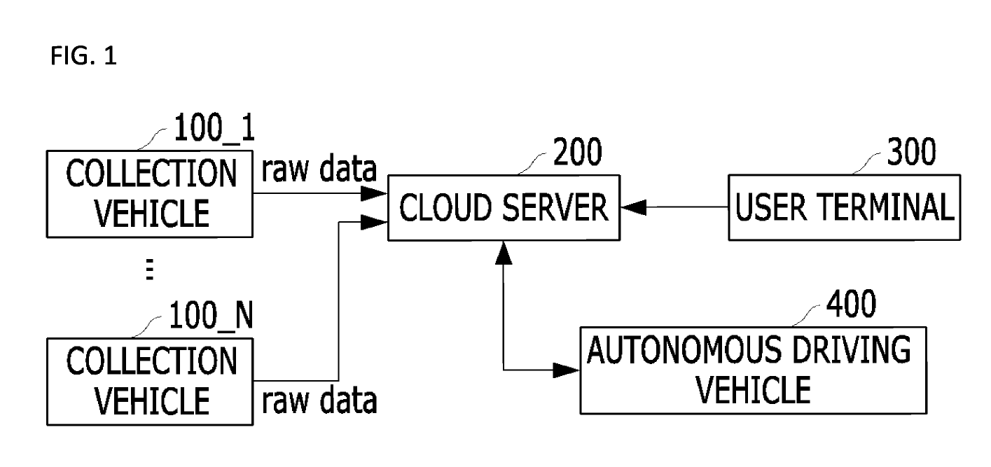

FIG. 1 is a conceptual diagram illustrating an autonomous driving service system for an autonomous driving vehicle according to an embodiment of the present invention.

As illustrated in FIG. 1, an autonomous driving service system for an autonomous driving vehicle according to an embodiment of the present invention includes a plurality of collection vehicles 100, a cloud server 200, a user terminal 300, and an autonomous driving vehicle 400.

In the autonomous driving service system for the autonomous driving vehicle according to an embodiment of the present invention, raw data of roads collected by the plurality of collection vehicles 100_1 to 100_N is transmitted to the cloud server 200 in order to generate a precise map, and the cloud server 200 generates the precise map by processing the raw data, makes the generated precise map into a database (DB), and manage the obtained DB. In addition, when a destination is input to the user terminal 300 by an operation of a driver of the autonomous driving vehicle 400 desiring to perform autonomous driving, the user terminal 300 transmits, to the cloud server 200, an autonomous driving map data request command for autonomous driving from a departure point (a current position of the autonomous driving vehicle 400 or a point input by the driver) to the destination. The cloud server 200 searches for precise map data established in advance in response to the request of the user terminal 300, and transmits, to the autonomous driving vehicle 400, autonomous driving map data (routing data) including a road route and guidance information for the autonomous driving vehicle 400 reaching the destination from the departure point through autonomous driving. Accordingly, the autonomous driving vehicle 400 may reach the destination by performing autonomous driving in accordance with the received routing data.

For this, the plurality of collection vehicles 100 collect raw data for generating the precise map which is used when performing autonomous driving. Here, the raw data may be basically image data of front sides of the collection vehicles 100. Alternatively, the raw data may be feature data extracted from the image data. In this instance, the feature data may be data (a dotted line, a solid line, etc.) containing road mark-shaped geometry information extracted from image data, or data containing position information of landmarks.

In addition, the collection vehicles 100 may be a plurality of vehicles 100_1 to 100_N which are driving at different locations. In this instance, the autonomous driving vehicle 400 according to an embodiment of the present invention may also perform the function of the collection vehicles 100, and therefore the autonomous driving vehicle 400 and the collection vehicles 100 may be the same vehicle. However, in the present invention, assuming that the autonomous driving vehicle 400 and the collection vehicles 100 are separate vehicles from each other, description will be made.

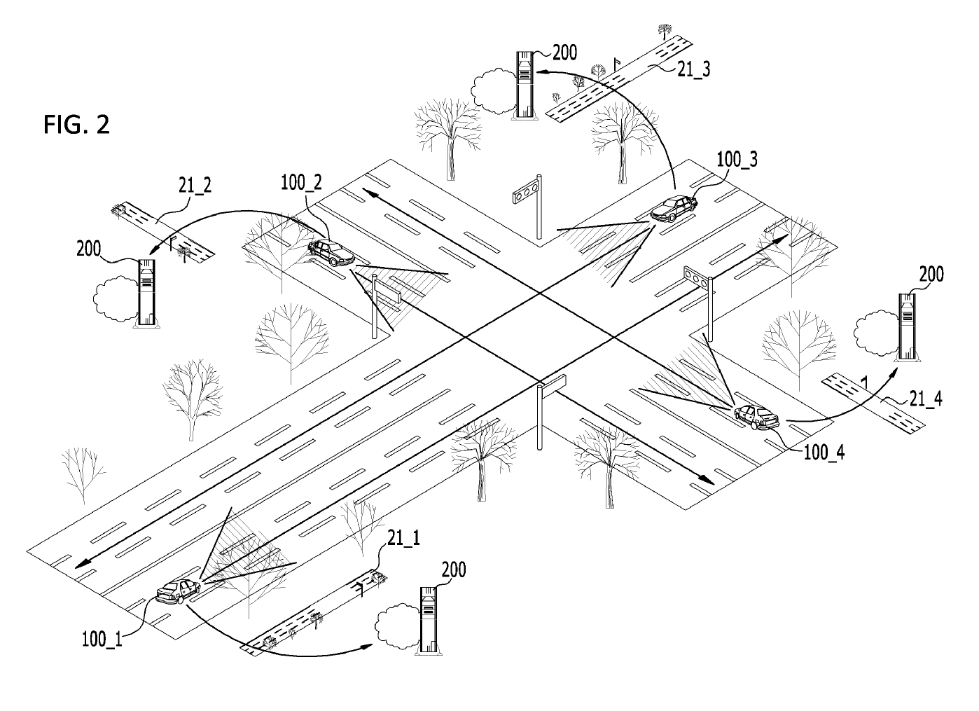

The collection vehicles 100 transmit the collected raw data to the cloud server 200 in real time. For example, as illustrated in FIG. 2, each of the plurality of collection vehicles 100_1 to 100_4 which are driving on an arbitrary road in which an intersection is present may be connected to the cloud server 200 through a wireless communication, and transmit raw data 21_1 to 21_4 collected while the respective collection vehicles 100_1 to 100_4 are driving, to the cloud server 200.

The collection vehicles 100 may be an MMS (mobile mapping system) vehicle or an ADAS (advanced driving assistance system) vehicle.

The MMS vehicle refers to a collection vehicle equipped with a plurality of various sensors and a raw data collection system. Here, the plurality of sensors may be a GPS, a vision sensor, a lidar, a radar sensor, or the like. The MMS vehicle is a vehicle for the purpose of collecting raw data for generating a precise map, and may collect data of a larger area at a time.

The ADAS vehicle refers to a vehicle equipped with an ADAS for driving support of a driver, and includes a vision sensor, a radar sensor, or the like mounted therein and provides functions such as detecting lane departure of a vehicle, detecting a collision risk of a vehicle, and the like. The ADAS tends to be basically mounted in a vehicle according to the development of technologies related to the vehicle, and the vision sensor may be the most basic sensor for the ADAS vehicle.

As to the collection of the raw data for generating the precise map, the collected raw data has an enormous amount compared to that of legacy navigation map data, so that it takes a lot of time to process the collected data. Accordingly, an apparatus that can collect and transmit the raw data for generating the precise map may be mounted in the collection vehicles 100. This apparatus may include a program that can extract feature data from the above-mentioned image data, a communication device (e.g., an LTE communication module, or the like) for transmitting the raw data, a program that can be connected to an autonomous driving service system for an autonomous driving vehicle and transmit the collected raw data, and the like.

Preferably, the collection vehicles 100 according to an embodiment of the present invention may be a vehicle equipped with the ADAS. That is, the collection vehicles 100 of the autonomous driving service system for the autonomous driving vehicle according to an embodiment of the present invention may automatically collect the raw data during normal driving other than driving for the purpose of collecting map data.

In this manner, when the precise map is generated using the raw data collected from each of the plurality of collection vehicles 100, the accuracy of the precise map is gradually increased and a collection area may be gradually expanded. The vision sensor mounted in the collection vehicle (ADAS vehicle) 100 has a small collection area of the raw data due to its narrow field of view. Accordingly, when a map is generated by aggregating data collected by a plurality of ADAS vehicles which are driving on the same road, the accuracy of map data of the road may be increased.

For example, road marks of the left lane of a two-lane road may be collected by a first arbitrary vehicle, road marks of the right lane thereof may be collected by a second arbitrary vehicle, and landmarks may be collected by a third arbitrary vehicle. That is, the concept of the gradual expansion of the collection area means that road data of an arbitrary first road is collected by the first vehicle and road data of an arbitrary second road is collected by the second vehicle so that a precise map establishment area is gradually expanded.

The cloud server 200 may generate precise map data by processing the raw data received from the collection vehicles 100, make the generated precise map data into a database (DB), and manage the obtained DB.

In addition, the user terminal 300 connected to the autonomous driving vehicle 400 is switched into an autonomous driving mode, and then the cloud server 200 may receive a map data request command for autonomous driving from the user terminal 300. When receiving the map data request command for autonomous driving, the cloud server 200 may search for a road route for the autonomous driving vehicle 400 to reach a destination from a current location, search for autonomous driving map data (routing data) for the autonomous driving vehicle to perform autonomous driving in accordance with the searched road route, and transmit the searched autonomous driving map data to the autonomous driving vehicle 400.

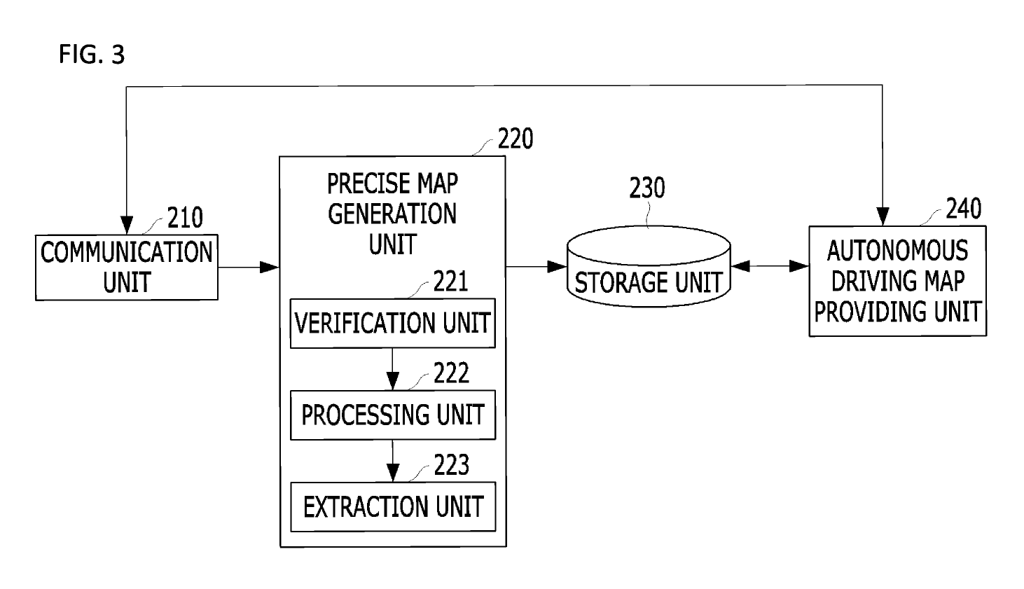

Hereinafter, the cloud server 200 of the autonomous driving service system for the autonomous driving vehicle according to an embodiment of the present invention will be described in detail with reference to FIG. 3.

FIG. 3 is a block diagram illustrating a cloud server of an autonomous driving service system for an autonomous driving vehicle according to an embodiment of the present invention.

As illustrated in FIG. 3, the cloud server 200 according to an embodiment of the present invention includes a communication unit 210, a precise map generation unit 220, a storage unit 230, and an autonomous driving map providing unit 240.

The communication unit 210 receives the raw data for establishing the precise map used in autonomous driving of a vehicle from the plurality of collection vehicles 100. Here, the communication unit 210 may transmit and receive data to and from the collection vehicles 100 through a mobile communication such as 3G, LTE, or the like. Alternatively, the communication unit 210 may transmit and receive data to and from the collection vehicles 100 through a wireless communication such as RF. In addition, the communication unit 210 may receive the raw data together with position coordinates of a vehicle that transmits the corresponding raw data.

In this instance, the communication unit 210 may receive the raw data from a vehicle which coincides with a vehicle identification (ID) stored in a separate memory (not shown) in advance. The Vehicle ID for each of the plurality of collection vehicles 100 that collect and transmit the raw data may be stored in the separate memory. Such vehicle IDs may be added, deleted, and changed by an administrator in advance. In addition, the separate memory may be the same storage medium as the storage unit 230 that stores precise map data in the autonomous driving service system for the autonomous driving vehicle.

The precise map generation unit 220 generates the precise map data using the raw data received via the communication unit 210. Specifically, the precise map generation unit 220 verifies the raw data, generates road marks and landmarks which have been cleaned through the verification step, and extracts road network data for each lane from the generated road marks and landmarks. For this, the precise map generation unit 220 includes a verification unit 221, a processing unit 222, and an extraction unit 223.

The verification unit 221 verifies the raw data received via the communication unit 210. The verification unit 221 removes overlapped data when the raw data received through the communication unit 210 and precise map data established in advance are overlapped with each other. In addition, the verification unit 221 may perform filtering when there is an error in the raw data. For example, the verification unit 221 may detect an error of the raw data received via the communication unit 210 through an error detection processor.

In addition, the verification unit 221 determines whether updating such as newly adding or changing the precise map data established in advance occurs based on the verification result of the received raw data. When the updating occurs based on the determination result, the raw data in which the updating occurs may be subsequently processed by the processing unit 222 so that the precise map data established in advance may be updated. For example, the processing unit 222 may perform a matching step between a part of the precise map data established in advance and the raw data.

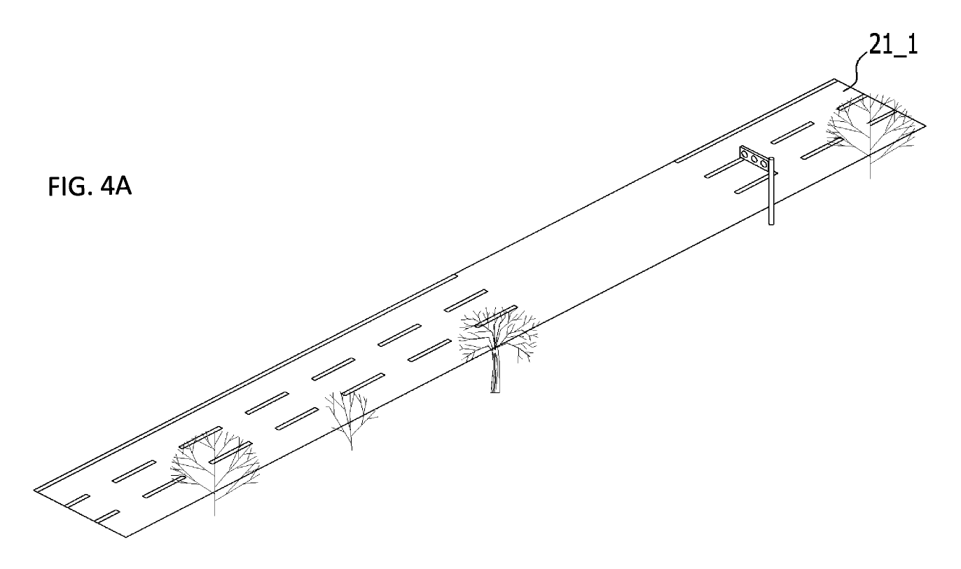

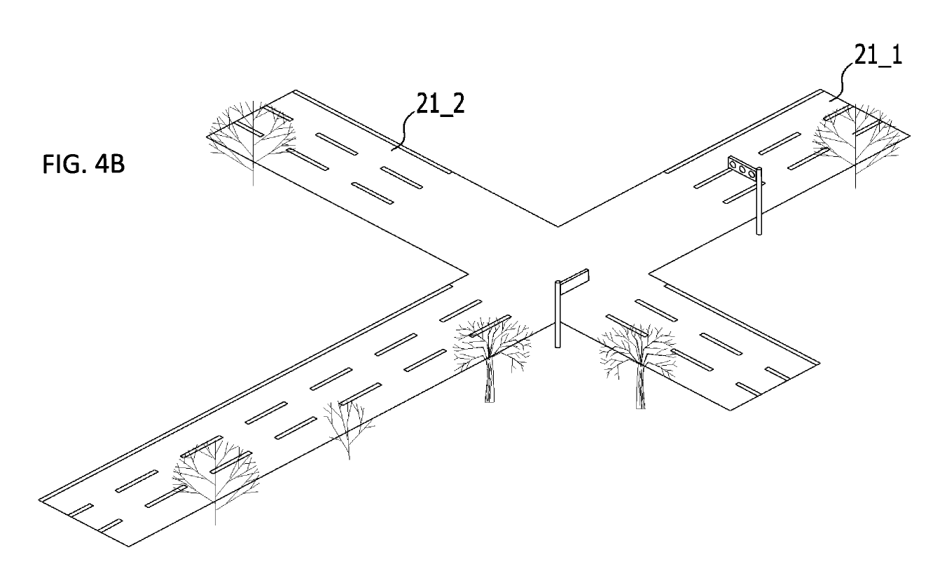

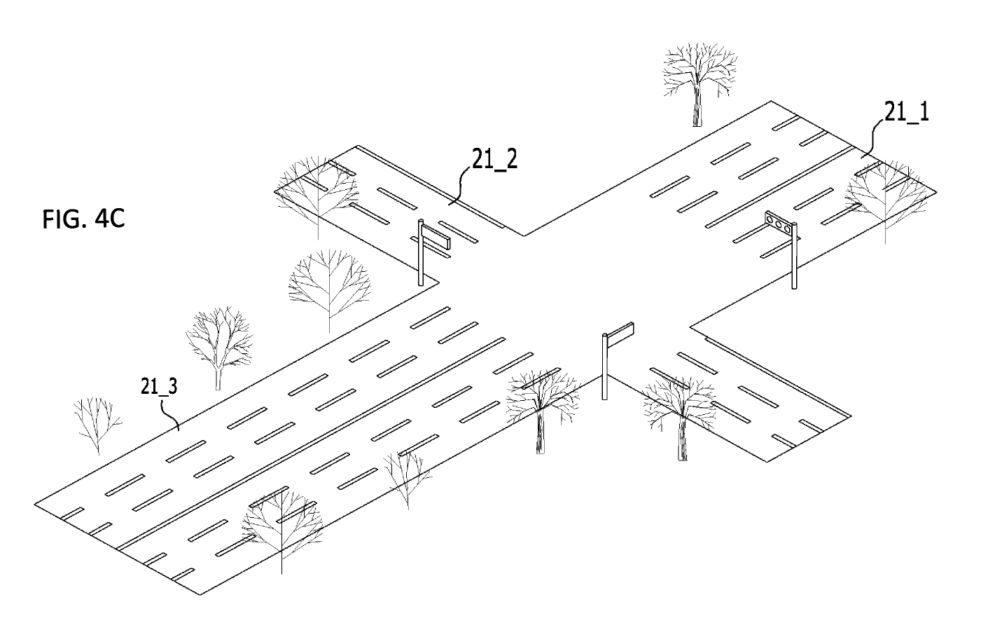

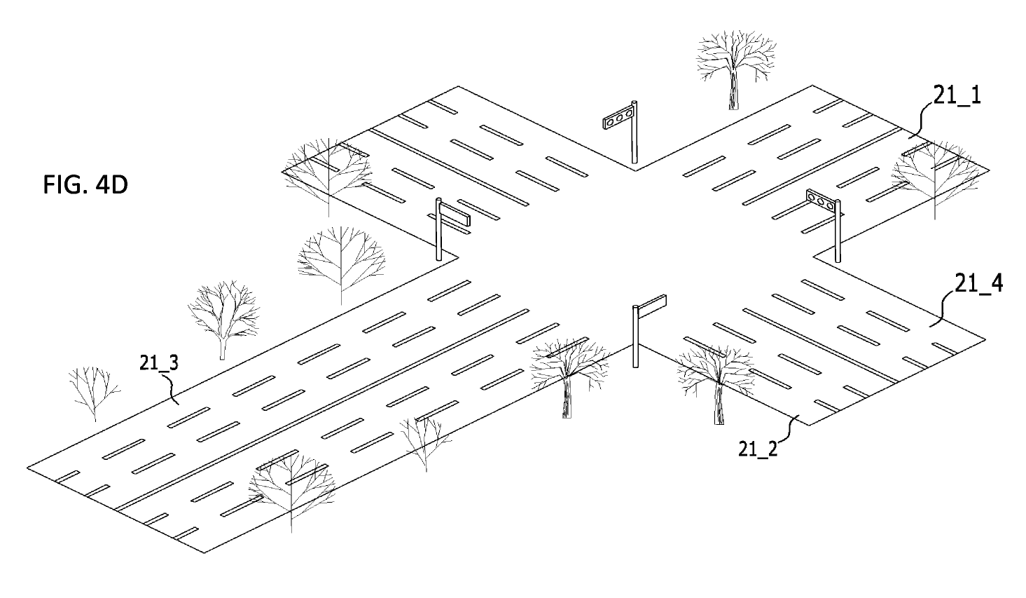

For example, as illustrated in FIG. 2, the processing unit 222 that has received, via the communication unit 210, the raw data 21_1 to 21_4 collected while the respective vehicles 100_1 to 100_4 are driving may perform matching on the raw data 21_1 to 21_4, so that precise map data for the corresponding intersection may be generated. Specifically, as illustrated in FIG. 4A, the raw data 21_1 collected by the arbitrary vehicle 100_1 and the raw data 21_2 collected by another arbitrary vehicle 100_2 are matched so that precise map data may be generated as illustrated in FIG. 4B, and the raw data 21_3 and 21_4 collected from the other respective vehicles 100_3 and 100_4 are matched so that precise map data may be generated as illustrated in FIGS. 4C and 4D.

In addition, the processing unit 222 allocates attribute values to features involved in the raw data. In this instance, the attribute value may be a kind of road marks specified in the pavement marking standards by pavement marking regulations, such as centerlines, U-turn lanes, lanes, bus lanes, lanes for no lane change, guide lines, safe zones, and the like, or may be a kind of landmarks such as traffic signs, road signs, traffic lights, and the like.

The extraction unit 223 extracts the road network data for each lane using information which has been processed and cleaned by the processing unit 222. In this instance, the road network data for each lane may be used to search for lane-level route guidance (routing) information for autonomous driving of a vehicle. For example, the road network data for each lane includes lane-link information linearly indicating lanes on a road and lane-node information indicating points at which the attribute of the lane link is changed such as intersection points, U-turn points, and the like.

The lane-link information includes ID information of a lane link, start lane node and end lane node information of the lane link, lane information, lane category information, parent link ID information, and geometry information. Here, the lane information is information indicating corresponding data is data of which lane with respect to an intersection, and the lane category information indicates whether the corresponding lane is a bus lane or a normal lane. In addition, the parent link ID may be an ID (a link ID of legacy road network data) of an upper link, and the geometry information indicates three-dimensional (x, y, and z) geometry information of the lane link, that is, a polyline.

The lane-node information includes ID information of a lane node, adjacent exit lane-link information, parent node ID information, and geometry information. Here, the adjacent exit lane-link information indicates information about a link of which the corresponding node among links connected to the lane node is a start node. The parent node ID is an ID (a node ID of legacy road network data) of an upper node. Here, the reason why the parent link ID information and the parent node ID information are included is to share them together with road attribute information and also to utilize them together with rotation lane information.

The road marks, the landmarks, and the road network data for each lane which are finally generated by the respective components of the precise map generation unit 220 may be made into a DB, and stored and managed in the storage unit 230 as precise map data. In this instance, the precise map data may be stored in the same storage medium together with legacy navigation map data. Alternatively, the precise map data may be stored in a separate storage medium from the legacy navigation map data. In this instance, the navigation map data may be road-level road network data other than lane-level road network data for each lane.

When an autonomous driving map data request command is received from the user terminal 300, road route guidance (routing) information may be searched from the precise map data stored in the storage unit 230 in accordance with a road route on which the autonomous driving vehicle 400 desires to drive, and provided.

In general, information required for a vehicle to perform autonomous driving is routing data from a departure point to a destination, real-time situational awareness information during driving, and exact location/posture information of the autonomous driving vehicle. Here, the routing data is road route guidance information including a mission for a vehicle to follow a road route, and to follow this, current location and posture of the autonomous driving vehicle should be accurately determined. In the situational awareness, an obstacle may be recognized using a variety of sensors mounted in the corresponding vehicle and a determination and control on the recognized obstacle may be performed.

The routing data for the road route may be generated using the road network data for each lane. In addition, the location/posture information of the autonomous driving vehicle may be calculated by recognizing road marks and landmarks using a high performance GPS or vision sensor and mapping GPS information or the recognized road marks and landmarks and the precise map data established in advance.

When the autonomous driving map data request command for the autonomous driving vehicle is received from the user terminal 300, the autonomous driving map providing unit 240 may search for the autonomous driving map data (routing data) in accordance with the road route from the precise map data of the storage unit 230, and transmit the searched routing data to the autonomous driving vehicle 400.

The autonomous driving map providing unit 240 may receive the request command of the user terminal 300 via the communication unit 210. Alternatively, the autonomous driving map providing unit 240 may receive the request command via a separate wireless communication module.

In addition, the autonomous driving map providing unit 240 may transmit the searched autonomous driving map data to the autonomous driving vehicle 400 via the communication unit 210. Alternatively, the autonomous driving map providing unit 240 may transmit the searched autonomous driving map data to the autonomous driving vehicle 400 via a wireless communication module separate from the communication unit 210. In the present invention, assuming that the autonomous driving map data is transmitted to the autonomous driving vehicle 400 via the communication unit 210, description will be made.

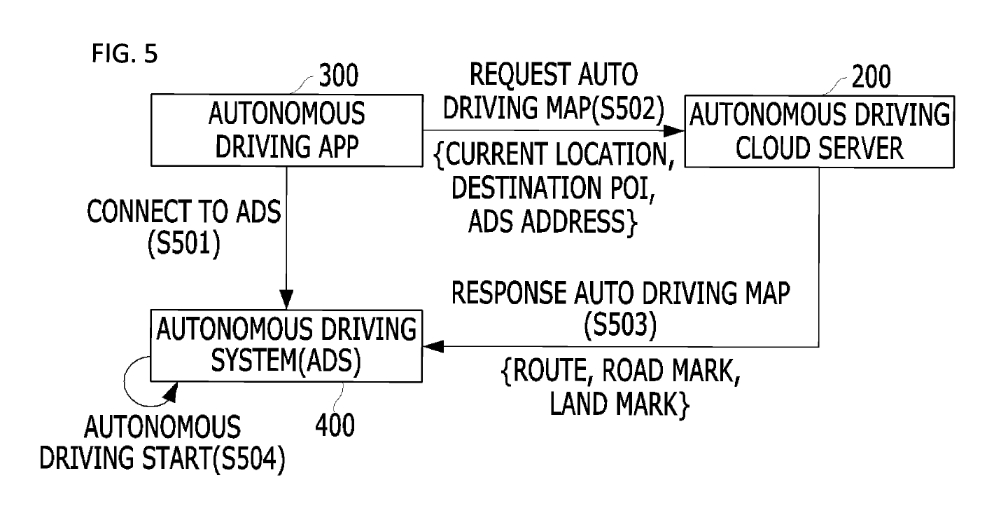

Specifically, the user terminal 300 and the autonomous driving vehicle 400 in addition to the autonomous driving map providing unit 240 of the cloud server 200 may be operated via the process shown in FIG. 5.

First, in operation 5501, when it is switched into an autonomous driving mode, the user terminal 300 is connected to the autonomous driving vehicle 400 (connection to autonomous driving system (ADS)) and acquires profile information of the autonomous driving vehicle 400. In this instance, the autonomous driving mode may be switched in such a manner that an autonomous driving app within the user terminal 300 is executed by a driver's operation of the autonomous driving vehicle 400, or switched through a separate button input. In addition, the profile information may be unique identification (ID) information (e.g., IP address (ADS address)) of the autonomous driving vehicle 400.

In addition, each other's unique ID information may be registered in advance in the autonomous driving vehicle 400 and the user terminal 300. When the user terminal 300 is located within the autonomous driving vehicle 400, the autonomous driving vehicle 400 and the user terminal 300 may be connected to each other, and in this case, communication may be performed via short-range wireless communication (e.g., Bluetooth).

In addition, when it is switched into the autonomous driving mode, the user terminal 300 may receive destination (point of interest (POI)) information of the autonomous driving vehicle 400.

Next, in operation 5502, the user terminal 300 is connected to the cloud server 200, and then requests autonomous driving map data (routing data) for autonomous driving. In this instance, the user terminal 300 transmits an autonomous driving map data request command including the profile information of the autonomous driving vehicle 400 which has been acquired in operation 5501, to the cloud server 200. When transmitting the autonomous driving map data request command, the user terminal 300 may transmit current location information of the corresponding vehicle, destination (POI) information input by a driver, and profile information to the cloud server 200.

In this instance, the current location information of the autonomous driving vehicle may be position coordinate information of a GPS mounted in the user terminal 300. Alternatively, the current location information of the autonomous driving vehicle may be position coordinate information of a GPS mounted in the autonomous driving vehicle. The autonomous driving map data request command including the current location information, destination (POI) information, and profile information of the autonomous driving vehicle may be transmitted to the autonomous driving map providing unit 240 via the communication unit 210 of the cloud server 200.

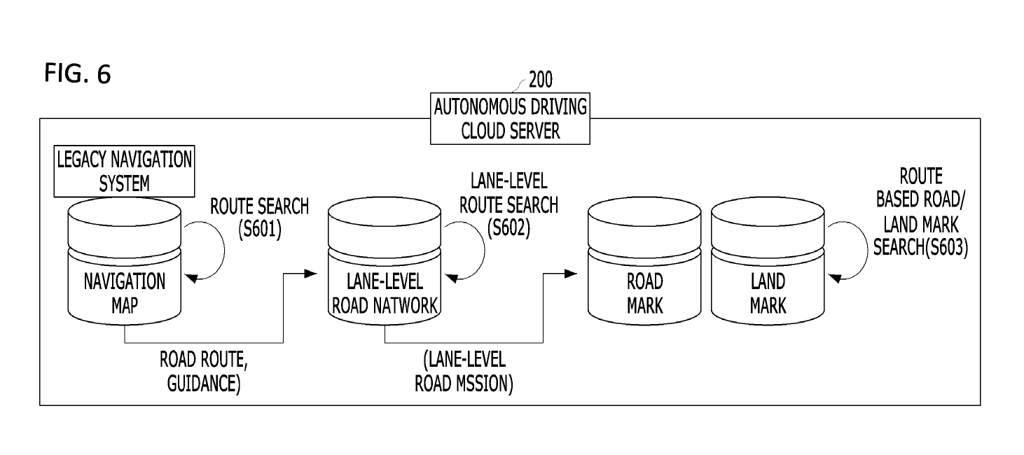

In operation 5503, the autonomous driving map providing unit 240 of the cloud server 200 which has received the autonomous driving map data request command searches for a road route for the autonomous driving vehicle 400 to reach the destination from the current location of the autonomous driving vehicle 400, acquires autonomous driving map data for following the road route, and transmits the acquired autonomous driving map data to an autonomous driving apparatus of the autonomous driving vehicle. In this instance, the autonomous driving map providing unit 240 of the cloud server 200 may search for and acquire the autonomous driving map data via the process shown in FIG. 6.

First, in operation 5601, the autonomous driving map providing unit 240 searches (route search) for the road route for the autonomous driving vehicle to reach the destination from the current location of the autonomous driving vehicle which has been received from the user terminal 300, by retrieving navigation map data used in a legacy navigation system. In this instance, the cloud server 200 may search for a road-level route and guidance information. The legacy navigation system provides only the road-level route for a vehicle to reach the destination from the current location of the vehicle, and does not provide information about a lane in which the vehicle should drive, that is, lane-level information.

Accordingly, in operation 5602, the autonomous driving map providing unit 240 of the cloud server 200 searches for (lane-level route search) a lane-level route based on the searched road-level route. In this instance, the autonomous driving map providing unit 240 searches for the lane-level route including lane-link information indicating a lane in which the corresponding vehicle should actually drive among a plurality of lanes of the road-level route and lane-node information indicating the attribute for the lane link.

In addition, the autonomous driving map providing unit 240 may further search for mission information of a point at which a change in the driving of the autonomous driving vehicle such as rotation or lane change is required while the autonomous driving vehicle follows the road route. For example, the mission information may include information such as {x, y, θ, speed, maneuver, and turn}. In this instance, (x, y) denotes a location of a vehicle, θ denotes a vehicle heading direction due north, speed denotes a speed limit, maneuver (advancing instruction) includes {forward, backward, stop, and finish}, and turn (rotation instruction) includes {lane-change-left, lane-change-right, U-turn-left, and U-turn-right}.

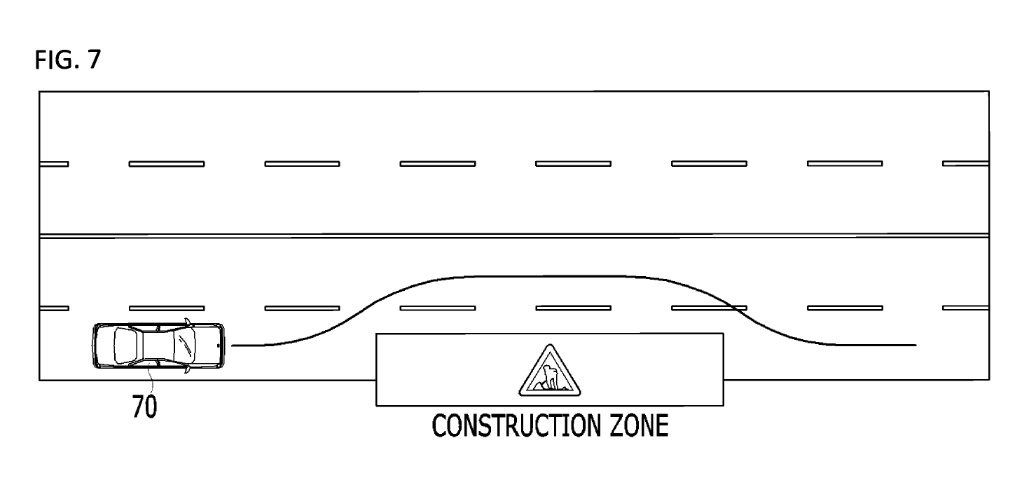

In this instance, the autonomous driving map providing unit 240 may search for the lane-level route and mission information in the lane-level route so that the autonomous driving vehicle 400 may drive by performing a lane change, as necessary, using information about a lane (a construction zone, an accident area, or the like) in which driving is prohibited. Here, prohibition information for each lane on the road can be seen through system interlocking with relevant agencies such as local government, the Korea Expressway Corporation, and the like. For this, the prohibition information for each lane of the systems of the relevant agencies may be stored in the storage unit 230 at a predetermined interval or in real time. Alternatively, raw data collected by a preceding ADAS vehicle 70 is generated as precise map data and stored in the storage unit 230 as illustrated in FIG. 7, and therefore the prohibition information for each lane can be seen from autonomous driving map data for the subsequent vehicles.

In addition, in operation 5603, the autonomous driving map providing unit 240 may further search for road mark information and landmark information in accordance with the road route. For example, the autonomous driving map providing unit 240 may transmit, to the autonomous driving vehicle 400, information about road marks and landmarks which are visually recognized by the driver during driving of the autonomous driving vehicle along the road route, particularly, the lane-level route. Such road mark and landmark information may be output to a screen together with the road route through a display device while the autonomous driving vehicle 400 performs autonomous driving, and the output road mark and landmark information may be provided to the driver.

The autonomous driving vehicle 400 may perform autonomous driving in accordance with the autonomous driving map data (routing data) received from the cloud server 200. For this, the autonomous driving vehicle 400 may be a vehicle in which an ADS for controlling autonomous driving of the vehicle is implemented. The ADS may control autonomous driving of the autonomous driving vehicle via a plurality of control units (e.g., BCM (body control module)) of the autonomous driving vehicle 400 in addition to an ECU (electronic control unit) thereof.

For example, the autonomous driving vehicle 400 may perform autonomous driving in accordance with the guidance information and the road-level route which are included in the routing data. In this instance, the autonomous driving vehicle 400 may perform stop, acceleration, lane change, and the like by controlling the speed, braking, and steering of the vehicle in accordance with the mission information at the current location, while driving along an actual lane in which the vehicle should actually drive along the lane-level route.

As described above, according to the embodiments of the present invention, the collection vehicle such as an MMS vehicle or an ADAS vehicle may collect raw data for generating precise map data, and the cloud server may establish the precise map data based on the collected raw data, and therefore the accuracy of the precise map data may be gradually increased and a collection area of the raw data may be gradually expanded. In addition, the cloud server may provide autonomous driving map data in accordance with a road route to a vehicle by searching for the precise map data for autonomous driving of the autonomous driving vehicle, so that the autonomous driving of the autonomous driving vehicle may be controlled using the autonomous driving map data, and therefore a vehicle equipped with the autonomous driving apparatus may perform unmanned driving anywhere anytime.

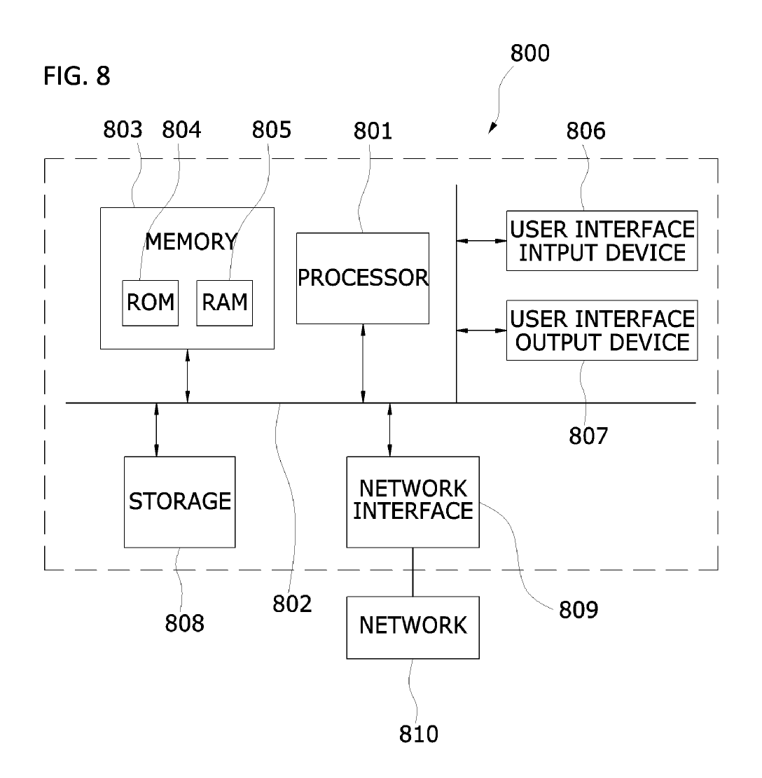

An embodiment of the present invention may be implemented in a computer system, e.g., as a computer readable medium. As shown in in FIG. 8, a computer system 800 may include one or more of a processor 801, a memory x23, a user input device 806, a user output device 807, and a storage 808, each of which communicates through a bus 802. The computer system 800 may also include a network interface 809 that is coupled to a network 810. The processor 801 may be a central processing unit (CPU) or a semiconductor device that executes processing instructions stored in the memory 803 and/or the storage 808. The memory 803 and the storage 808 may include various forms of volatile or non-volatile storage media. For example, the memory may include a read-only memory (ROM) 804 and a random access memory (RAM) 805.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

As above, the configuration of the present invention has been described in detail through the preferred embodiments of the present invention, but one of ordinary skill in the art will appreciate that the present invention may be embodied in other specific forms different from those disclosed in the present specification without changing the technical spirit or essential features of the present invention. Therefore, the embodiments described above are intended to be illustrative in all respects to be understood as non-limiting. The scope of the invention should be construed to be represented by the claims below rather than the foregoing description, and it should be interpreted that all changes or variations derived from the claims and the equivalent concept are included within the scope of the invention.

What is claimed is:

1. An autonomous driving service system for an autonomous driving vehicle comprising:
a user terminal that requests autonomous driving map data used for an autonomous driving vehicle to perform autonomous driving from a departure point set in advance to a destination; and
a cloud server that establishes and manages precise map data based on raw data collected from a plurality of collection vehicles which are driving in mutually different locations, acquires the autonomous driving map data by searching for the precise map data in response to the request for autonomous driving map data of the user terminal, and transmits the acquired autonomous driving map data to the autonomous driving vehicle.

2. The autonomous driving service system of claim 1, wherein the raw data is feature data including at least one of image data acquired via a vision sensor provided in each of the plurality of collection vehicles, road mark-shaped geometry information extracted from the image data, and position information of landmarks.

3. The autonomous driving service system of claim 1, wherein the cloud server receives the raw data from at least one of an MMS (mobile mapping system) vehicle equipped with an MMS and an ADAS (advanced driving assistance system) vehicle equipped with an ADAS.

4. The autonomous driving service system of claim 1, wherein, when it is switched into an autonomous driving mode, the user terminal transmits an autonomous driving map data request command including profile information, departure point information, and destination information of the autonomous driving vehicle to the cloud server.

5. The autonomous driving service system of claim 4, wherein the cloud server transmits the autonomous driving map data to the autonomous driving vehicle corresponding to unique identification (ID) information included in the profile information.

6. The autonomous driving service system of claim 4, wherein the cloud server includes
a precise map generation unit that generates the precise map data based on the received raw data,
a storage unit that stores the precise map data generated by the precise map data generation unit, and
an autonomous driving map providing unit that acquires the autonomous driving map data for the autonomous driving vehicle to reach the destination by searching for the precise map data stored in the storage unit when receiving the autonomous driving map data request command, and transmits the acquired autonomous driving map data to the autonomous driving vehicle.

7. The autonomous driving service system of claim 6, wherein the autonomous driving map providing unit acquires the autonomous driving map data including a road-level route and guidance information for the autonomous driving vehicle to reach the destination, a lane-level route including lane information about a lane in which the autonomous driving vehicle should drive on a road in accordance with the road-level route, and a mission of a point at which a change in driving of the autonomous driving vehicle is required, by searching for the precise map data of the storage unit.

8. A cloud server for providing autonomous driving service of an autonomous driving comprising:
a precise map generation unit that generates precise map data based on a plurality of pieces of raw data for a road in mutually different locations;
a storage unit that stores the generated precise map data; and
an autonomous driving map providing unit that acquires autonomous driving map data for an autonomous driving vehicle to reach a destination set in advance by searching for the precise map data stored in the storage unit when an autonomous driving map data request command is received, and transmits the acquired autonomous driving map data to the autonomous driving vehicle.

9. The cloud server of claim 8, wherein the raw data is feature data including at least one of image data acquired in mutually different locations, road mark-shaped geometry information extracted from the image data, and position information of landmarks.

10. The cloud server of claim 8, wherein the autonomous driving map providing unit acquires the autonomous driving map data including a road-level route and guidance information for the autonomous driving vehicle to reach the destination, a lane-level route including lane information about a lane in which the autonomous driving vehicle should drive on a road in accordance with the road-level route, and a mission of a point at which a change in driving of the autonomous driving vehicle is required, by searching for the precise map data of the storage unit.

11. The cloud server of claim 8, wherein the raw data is received from at least one of an MMS vehicle equipped with an MMS and an ADAS vehicle equipped with an ADAS.

12. The cloud server of claim 8, wherein the autonomous driving map data request command includes profile information, departure point information, and destination information of the autonomous driving vehicle.

13. The cloud server of claim 12, wherein the autonomous driving map providing unit transmits the autonomous driving map data to the autonomous driving vehicle corresponding to unique ID information included in the profile information.

14. A method for operating a cloud server of an autonomous driving service system for an autonomous driving vehicle, comprising:
receiving raw data for a road in mutually different locations;
generating and storing precise map data based on the raw data;
acquiring autonomous driving map data for the autonomous driving vehicle to perform autonomous driving from a departure point set in advance to a destination by searching for the precise map data; and
transmitting the acquired autonomous driving map data to the autonomous driving vehicle.

15. The method for operating the cloud server of claim 14, wherein the acquiring includes searching for the precise map data when receiving an autonomous driving map data request command including profile information, departure point information, and destination information of the autonomous driving vehicle.

16. The method for operating the cloud server of claim 14, wherein the raw data is feature data including at least one of image data of the road, road mark-shaped geometry information extracted from the image data, and position information of landmarks.

17. The method for operating the cloud server of claim 14, wherein the receiving includes receiving the raw data from at least one of an MMS vehicle equipped with an MMS and an ADAS vehicle equipped with an ADAS.

18. The method for operating the cloud server of claim 14, wherein the autonomous driving map data includes a road-level route and guidance information for reaching the destination from the departure point, a lane-level route including lane information about a lane in which the corresponding vehicle should drive in accordance with the road-level route, and a mission of a point at which a change in driving of the autonomous driving vehicle is required, by searching for the precise map data.

19. The method for operating the cloud server of claim 15, wherein the transmitting includes transmitting the autonomous driving map data to the autonomous driving vehicle corresponding to a unique ID included in the profile information.
